(19) United States
(12) Patent Application Publication
(10) Pub. No.: US 2025/0326641 A1
(43) Pub. Date: Oct. 23, 2025

(54) SELECTIVE TREATMENT OF NITRATE FOR BRINE REGENERATION

(71) Applicant: TOXSORB LTD., Kiryat Shmona (IL)

(72) Inventors: Rotem SADE, Kibutz Ein Zivan (IL); Yotam GONEN, Kibbutz Mahanaim (IL); Amos ROICH, Hulata (IL); Tamir CARMON, Lehavot Habashan (IL); MIchael KOLLMANN, Pardes Hanna-Karkur (IL)

(73) Assignee: TOXSORB LTD., Kiryat Shmona (IL)

(21) Appl. No.: 18/866,928

(22) PCT Filed: May 8, 2023
(86) PCT No.: PCT/IL2023/050465

§ 371 Date: Nov. 18, 2024

(30) Foreign Application Priority Data
May 23, 2022 (IL) 293253

(51) Int. Cl. C01B 21/42; C01B 21/02; C02F 1/20; C02F 1/28; C02F 101/16

(52) U.S. Cl. CPC C01B 21/42; C01B 21/02; C02F 1/20; C02F 1/283; C02F 2101/163; C02F 2303/16

(57) ABSTRACT

The present disclosure concerns processes for removal of nitrate from nitrate-rich brines, typically selective removal that permits reclaiming the nitrate after such removal.

### TECHNOLOGICAL FIELD

The present disclosure concerns processes for removal of nitrate from nitrate-rich brines, typically selective removal that permits reclaiming the nitrate after removal.

### BACKGROUND ART

References considered to be relevant as background to the presently disclosed subject matter are listed below:
Bergquist, A. M. et al., J. Am. Water Works Assoc. 2017, 109, E129-E143
Bergquist, A. M. et al., Water Res. 2016, 96, 177-187
Choe, J. K. et al., Water Res. 2015, 80, 267-280
Dortsiou, M. et al., Desalination 2009, 248, 923-930
Duan, S. et al., Water Res. 2020, 173, 115571
England, A. H. et al., Chem. Phys. Lett. 2011, 514, 187-195
Huo, X. et al., Water Res. 2020, 175, 115688
Jensen, V. B. et al., J. Am. Water Works Assoc. 2016, 108, E276-E289
Jensen, V. B. et al., Critical Reviews in Environmental Science and Technology 2014, 2203-2286
Lehman, S. G. et al., Water Res. 2008, 42, 969-976
Mirabi, M. et al., Process Saf. Environ. Prot. 2017, 111, 627-634
Paidar, M. et al., Water Environ. Res. 2004, 76, 2691-2698
Pintar, A. et al., Appl. Catal. B Environ. 2006, 63, 150-159
Van Ginkel, S. W. et al., Water Res. 2008, 42, 4197-4205

Acknowledgement of the above references herein is not to be inferred as meaning that these are in any way relevant to the patentability of the presently disclosed subject matter.

### BACKGROUND

The contamination of water by nitrate (NO₃⁻) is a worldwide problem, with its primary cause being the application of fertilizer in agriculture, leading to groundwater contamination. The toxicity of nitrate in humans is mainly related to methemoglobinemia and cancer, although other health risks have also been reported. To reduce the health risks posed by nitrate in drinking water, the standards and guidelines of the World Health Organization (WHO) and the US Environmental Protection Agency (EPA) currently limit nitrate (as NO₃⁻) concentration in drinking water to 50 mg/l and 44 mg/l, respectively.

In many cases, the nitrate concentration in water sources exceeds the standards set by the regulators. For example, in Israel, nitrate pollution is responsible for 104 (48%) groundwater wells that were declared out of compliance with drinking water standards (<70 mg/l). In Germany and Spain, respectively, 28% and 71% of the EU-28 groundwater stations, nitrate concentrations exceeded the 50 mg/l limits set by the EU, and on average more than 10% of all groundwater sources in the EU-28 exhibit nitrate concentration of >50 mg/l. In the USA, it was estimated that 20% of the wells exhibit nitrate concentration above the EPA standard. In China, it was reported that the average groundwater concentration is >44 mg/l in 8 out of 33 provinces.

The prevalence of nitrate contamination in groundwater led to the development of treatment techniques. Ion-exchange (IX) is a well-established technology for nitrate removal; however, brine produced during the regeneration of the IX resins creates an environmental and economic impediment (Jensen et al., 2014; Jensen et al., 2016). The brine disposal is the primary cost driver of the IX technology and is sometimes prohibitive. Developing a method that will allow brine reuse can lead to a more efficient implementation of the IX technology.

Brine reuse in IX systems is a well-known concept but has had almost no commercial use reported to date. To facilitate brine reuse, one has to selectively remove the nitrate from the brine and use it again for IX regeneration. The IX system that includes brine reuse is sometimes called the “IX hybrid system”.

Several researchers have suggested technologies for selective nitrate removal in hybrid IX systems. Lehman et al. (2008) demonstrated the feasibility of using a biological reactor to treat brine from IX regeneration. In this technology, salt-tolerant bacteria are used to convert nitrate to N₂ gas. A combination of zero-valent magnesium and powder-activated carbon was suggested by Mirabi et al. (2017) as a method for nitrate reduction in a hybrid system. Electrochemical reduction of nitrate in IX brine is another application tested by several groups (Dortsiou et al., 2009; Duan et al., 2020; Paidar et al., 2004). In this method, an electrical current is applied through designated electrodes to reduce the nitrate to N₂ though some N₂O (Dortsiou, supra) and NH₃ (Paidar, supra) gases are also produced. The photocatalytic method in hybrid IX systems has also been demonstrated when nitrate was reduced on a catalyst under irradiated light. It produced N₂ with a selectivity of 85% (i.e. 15% of the nitrate was converted to ammonium). Catalytic hydrogenation is another potential method for nitrate reduction in hybrid systems (Bergquist et al., 2017, 2016; Choe et al., 2015; England et al., 2011). Here, hydrogen gas reduces the nitrate on a bimetallic catalyst. Currently, the low activity of the catalyst is one of the reasons that prevent the scale-up of this technology (Bergquist, supra; Choe, supra).

All of the technologies mentioned above aimed to reduce the nitrate to atmospheric nitrogen (i.e. N₂), ignoring the value of nitrate as a macronutrient in agriculture. Lately, Huo et al. (2020) showed a method to recover the nitrogen from IX brine as ammonium, using a combination of catalytic reduction and membrane distillation. In the first step, the nitrate was reduced to ammonium by catalytic hydrogenation with a ruthenium-based catalyst. This step was followed by membrane distillation of ammonia into a sulfuric acid solution to produce an ammonium sulfate solution.

### General Description

In the present disclosure, a method for recovering the nitrate from brine is described and demonstrated, based on the transformation of the nitrate to a gaseous nitro-oxide species, such as NO, NO₂, and HNO₂, permitting selective and effective removal of nitrate from the brine. The gaseous nitrogen oxide species can then be further treated to obtain high purity nitric acid. In other words, the methods described herein provide selective treatment to brines, enabling regeneration of the brine for further use by removal of nitrate therefrom, while permitting the transforming of the nitrate into valuable products via gaseous species. The processes of the present disclosure are also suitable for recovery of nitrate from spent nitric acid by employing the same process steps and conditions.

According to one of its aspects, the present disclosure provides a process for removal of nitrate from nitrate-containing brine, the process comprising:
contacting, in a reactor, said nitrate-containing brine with an active medium, under conditions permitting conversion of said nitrate into nitrogen oxide gaseous products, and
removing said nitrogen oxide gaseous products from the reactor, thereby reducing the concentration of said nitrate in the nitrate-containing brine,
said conditions being selected to minimize formation of ammonia in the reactor.

In processes of the present disclosure, nitrate (NO₃⁻) rich brines are treated by contacting, under suitable conditions, with an active medium that is capable to reduce the nitrate ion into one or more nitrogen oxides (NOx) gaseous products. Unlike processes known in the art, in which ammonia is produced, the inventors have surprisingly found that by careful selection of process conditions, maximal NOx generation can be obtained, without substantive generation of ammonia (NH₃) within the reactor. Without wishing to be bound by theory, formation of ammonia, in addition to reducing the overall efficiency of the process, is a hazardous material which is difficult to treat or remove from the system, as it can be absorbed by the active medium and reduce its activity/efficiency.

The term brine means to denote a concentrated aqueous solution of one or more salts, typically water soluble salts. The brine is thus rich in one or more cations and anions, that should typically be removed, or their concentrations reduced below a threshold value in order to permit reuse of the solution for other purposes. The processes of the present disclosure are aimed at treating nitrate-containing brines; the brine can further comprise one or more other ionic species, for example, chloride, sulfate, metal cations, and others.

According to some embodiments, the brine comprises at least 100 ppm of nitrate.

The brine, by some embodiments, can be selected from one or more of regeneration brine from an ion-exchange system, municipal wastewater, agricultural wastewater, industrial wastewater, waste brine from evaporation ponds, reverse osmosis brine, spent nitric acid, mine water, and others.

The brine can, by some embodiments, be treated to remove one or more ionic species (different from nitrate), organic materials, and/or volatile components.

By some embodiments, the process comprises pre-treating the nitrate-containing brine before introduction into the reactor to remove volatile contaminants, for example by heating, vacuum treating, etc.

According to other embodiments, the process comprises pre-treating the nitrate-containing brine by filtering, sedimentation, precipitation, complexation, etc. to remove solid matter and/or ions different from nitrate from the brine.

In the process, the nitrate-containing brine is contacted with the active medium in order to reduce the nitrate to NOx products. Nitrogen oxide gaseous products, or NOx, typically refer to mono-nitrogen oxides in gas form. The predominant NOx products are nitric oxide (NO) and nitrogen dioxide (NO₂), as well as nitrous acid (HNO₂). Other nitrogen compounds such as dinitrogen dioxide (N₂O₂), dinitrogen trioxide (N₂O₃) and dinitrogen tetraoxide (N₂O₄) might be present as well. Namely, under the conditions in the reactor, a chemical reduction reaction takes place on the surface of the active medium, according to the following scheme.

Nitrate (NO₃⁻) in the brine is reduced on the surface of the active medium, in the presence of acidic conditions (namely in the presence of H⁺) and due to the conditions maintained in the reactor, to form NOx gaseous products, namely nitric oxide (NO) and nitrogen dioxide (NO₂):

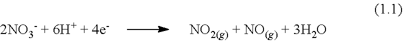

In the context of the present disclosure, an active medium denotes a material or composition of matter that is capable of reducing nitrate to one or more NOx species, without substantive fixation (or accumulation) of the nitrate onto the surface of the medium. The active medium can be a reduction substate and/or a catalytic substate.

The active medium should typically be chemically and mechanically stable under the conditions within the reactor, as detailed further below. By some embodiments, the active medium is activated carbon. The activated carbon can, by some embodiments, be modified or functionalized by one or more surface modifiers, e.g. cationic groups, anionic groups, complexation groups, one or more metal coating layers, etc.

According to some embodiments, the active medium is non-modified activated carbon.

The active medium is typically solid, and can be of any suitable form, such as powder, granules, flakes, beads, mesh, porous block, etc. By some embodiments, the active medium is in powder, granular or pellets form, having an average particle size of between about 0.01 mm and about 10 mm, for example between about 0.1 mm and about 10 mm, typically between about 0.5 mm and 5 mm.

The term averaged particle size refers to the arithmetic mean of measured diameters of the particles or granules. Where the particles or granules are not spherical, the term means to denote an arithmetic mean of the longest measured dimensions of the particles.

By some embodiments, the active medium occupies at least about 30% of the volume of the reactor, typically between about 30% and about 90% of the volume of the reactor, e.g. about 30%, 35%, 40%, 45%, 50%, 55%, 60%, 65%, 70%, 75%, 80%, 85% or 90% of the volume of the reactor.

In the reactor, the nitrate-containing brine can be contacted with the active medium in an up-flow manner, a down-flow manner or by horizontal flow. In other words, the nitrate-containing brine can be introduced into the vessel holding the active medium through the bottom of the vessel to form up-flow of the brine through the active medium, or from the top of the vessel to form down-flow of the brine. Alternatively, the nitrate-containing brine can be introduced through a side opening to form horizontal flow through the active medium.

By some preferred embodiments, the nitrate-containing brine can be introduced into the active medium in an up-flow manner. Such up-flow was found to assist in accelerating the degassing of products from the reaction area to permit an increase in the overall effectiveness of the process.

As noted, contacting between the nitrogen-containing brine and the active medium is carried out under conditions permitting formation of the nitrogen oxide gaseous products substantially without formation of ammonia.

According to some embodiments, said conditions comprise maintaining the reactor at a pH value of below about 3. Maintaining the pH below a value of about 3 permits pushing the equilibrium reaction in Equation (1.1) above to increase formation of nitrous acid (HNO₂), which, as noted, decomposes in the gas phase into NOx species. Maintaining an acidic pH can be obtained, for example, by adding one or more acids to the reactor.

By some embodiments, said conditions comprise maintaining the temperature of the reactor at a range of between about 60° C. and about 99° C. Applicants have found that maintaining the reactor at elevated temperatures not only increases the transformation of the NOx into the gas phase, but also permits optimal activity of the active medium. In addition, maintaining the reactor at elevated temperatures was found to minimize condensation of water and formation of nitric acid onto the reactor walls that can drip back into the reaction medium, thereby minimizing undesired re-formation of nitrates within the reactor.

According to some embodiments, said conditions comprise contacting the nitrate-containing brine with the active medium in an oxygen-devoid atmosphere. The inventors have surprisingly found that preventing introduction of oxygen into the reactor prevents the undesired formation of nitric acid within the reactor under the reaction conditions.

By some preferred embodiments, the reactor is maintained under sub-atmospheric pressure, assisting also in the transition of NOx from the aqueous phase into the gas phase. By carefully controlling the combination of elevated temperatures and sub-atmospheric pressure, control over the extent of NOx degassing can be obtained, thereby maximizing the formation of NOx species and the overall efficiency of the process.

According to some embodiments, the reactor is maintained at a pressure of between about-0.05 bar and about-0.2 bar. The pressure is typically kept above the saturation vapor pressure at the working temperature.

However, the process can also be carried out at atmospheric pressure, or at a pressure of between about 1 bar and 1.5 bar, in case where slower, passive removal of the formed gaseous products is desired.

By some embodiments, the process comprises introducing one or more inert gases into the reactor, for purging said nitrogen oxide gaseous products from the reactor. The one or more inert gases can be, for example, helium, argon, nitrogen, carbon dioxide, etc.

In order to further increase process efficiency, the nitrate-containing brine can, in some embodiments, be circulated or re-circulated through the active medium.

The NOx species formed in the process are removed from the reactor and can be collected or disposed. However, for economic purposes, these NOx products can form the basis for producing various desirable final products. Further, as these gases are considered environmentally non-friendly, it is also desirable to further process the NOx species into other products. Hence, by some embodiments, the process further comprises transferring said nitrogen oxide gaseous products to one or more further processing stages.

By some embodiments, said further processing comprises converting said nitrogen oxide gaseous products into nitric acid. Nitric acid (HNO₃) is of high commercial value in various industrial processes, and can further be used, for example, as a raw material for production of fertilizers. The production of nitric acid from nitrate brines also affords circular economy, producing a nitric acid as a final product from brines that contain nitrate ions from industries that utilize nitric acid (such as nitric acid from the production of fertilizers that contain nitrates).

The formation of nitric acid can occur directly form nitrogen dioxide, by capturing NO₂ in one or more aqueous traps, while the nitrogen oxide (NO) that is formed as a byproduct can be further reacted into NO₂ and returned into the aqueous trap for further reaction into nitric acid:

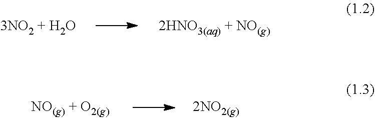

Another path to form nitric acid involves dinitrogen tetraoxide (N₂O₄). This species is rapidly obtained from NO₂ in the gas phase. The dinitrogen tetraoxide can then be reacted with water to form both nitric and nitrous acids,

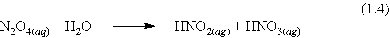

The nitrous acid (HNO₂) is further oxidized to nitric acid with atmospheric oxygen,

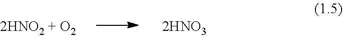

Alternatively, or in addition, the nitrogen oxide gaseous products can be treated to obtain harmless products, i.e. nitrogen gas and water. Hence, by some embodiments, the process comprises converting said nitrogen oxide gaseous products into nitrogen gas (N₂) and water (H₂O), that can be released to the atmosphere. By some embodiments, such converting is carried out in a catalytic convertor, e.g. standard catalytic convertors known in the art. By some other embodiments, the NOx treatment is carried out by contacting said nitrogen oxide gaseous products by reaction with an alkali or acid solution.

By another aspect, the present disclosure provides a process for removal of nitrate from nitrate-containing brine, the process comprising:
contacting, in a reactor, said nitrate-containing brine with an active medium comprising activated carbon, under conditions permitting conversion of said nitrate into nitrogen oxide gaseous products, and
removing said nitrogen oxide gaseous products from the reactor, thereby reducing the concentration of said nitrate in the nitrate-containing brine.

By another aspect of the present disclosure there is provided a process for recovery of nitrate in the form of nitric acid from nitrate-containing brine, the process comprising:
contacting, in a reactor, said nitrate-containing brine with an active medium, under conditions permitting conversion of said nitrate into nitrogen oxide gaseous products, said conditions being selected to minimize formation of ammonia in the reactor,
removing said nitrogen oxide gaseous products from the reactor, and
treating said nitrogen oxide gaseous products in one or more treatment stages, thereby obtaining nitric acid.

By some embodiments, said one or more treatment stages comprise contacting said nitrogen oxide gaseous products with oxygen. By other embodiments, said one or more treatment stages comprise contacting said nitrogen oxide gaseous products with water. By some other embodiments, the converting is carried out by contacting said nitrogen oxide gaseous products by reaction with an alkali solution or acid solution. By some embodiments, such converting is carried out in a catalytic convertor, e.g. standard catalytic convertors known in the art.

Processes of this disclosure can be used as stand-alone processes, in stand-alone facilities. Alternatively, the processes of this disclosure can be part of a larger process or system for treatment of wastewater or industrial wastes.

Processes of this disclosure can be employed in a batch-wise, a semi-continuous or a continuous manner.

As used herein, the term about is meant to encompass deviation of +10% from the specifically mentioned value of a parameter, such as temperature, pressure, concentration, etc.

Whenever a numerical range is indicated herein, it is meant to include any cited numeral (fractional or integral) within the indicated range. The phrases ranging/ranges between a first indicate number and a second indicate number and ranging/ranges from a first indicate number to a second indicate number are used herein interchangeably and are meant to include the first and second indicated numbers and all the fractional and integral numerals therebetween.

It is appreciated that certain features, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention.

The processes of the present disclosure involve numerous process steps which may or may not be associated with other common physical-chemical processes so as to achieve the desired purity and form of each of the isolated components. Unless otherwise indicated, such process steps, if present, may be set in different sequences without affecting the workability of the process and its efficacy in achieving the desired end result. As a person skilled in the art would appreciate, a sequence of steps may be employed and changed depending on various economical aspects, material availability, raw materials, environmental considerations, etc.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B are schematic representations of a system for implementing the process according to an embodiment of this disclosure in a down-flow circulation (FIG. 1A) and in an up-flow circulation (FIG. 1B).

FIG. 2 shows a break-through curve in the Hybrid IX Test.

FIG. 3 shows the nitrate concentrations in the reactor during the Recovery Tests.

FIGS. 4A-4B show the change in nitrate (NO₃⁻) and nitrite (NO₂) in the acid traps (FIG. 4A) and the alkaline traps (FIG. 4B) during the Recovery Tests.

FIG. 5 shows the % nitrate recovery in the Recovery Tests.

FIG. 6 shows the NO₃⁻ removal rate (in milligrams of NO₃⁻ per gram of activated per hour) as a function of the amount of removed nitrate for different types of activated carbon.

FIG. 7A is a schematic representation of a glass column used in the continuous test for assessing the impact of the direction of brine feed.

FIG. 7B shows removal rates of NO₃ in the continuous tests, as milligrams of NO₃⁻ per gram of AC per hour, as a function of the amount of removed nitrate for up-flow and down-flow configurations.

### DETAILED DESCRIPTION OF EMBODIMENTS

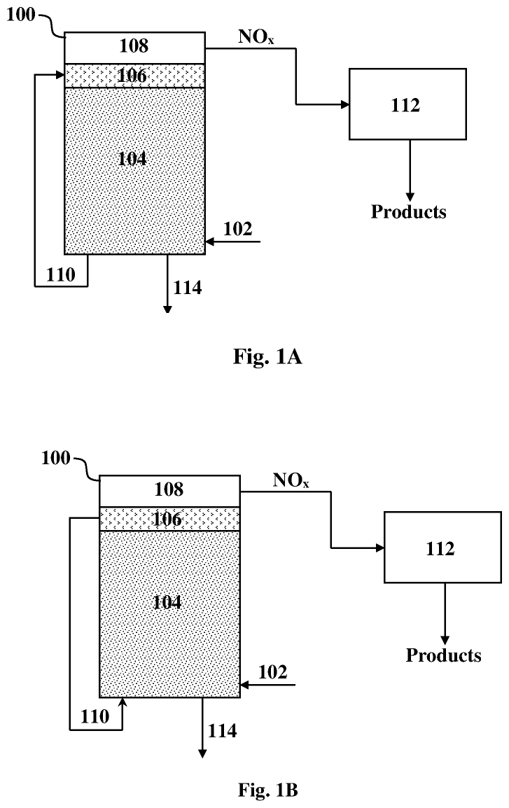

A schematic representation of a process and a suitable system for employing the process of this disclosure is shown in FIGS. 1A-1B. Reactor 100 holds active medium 104, which is selected to provide a reduction reaction of nitrate into NOx under the conditions of the process as described herein. The active medium 104 typically occupies at least 30% of the volume of reactor 100. Nitrate-containing brine is fed into the reactor at through feed inlet 102, and the reactor is maintained under conditions as described herein in order to obtain said reduction reaction. The brine can be circulated via loop 110 through the active medium, e.g. drained from the bottom of the reactor and fed back into the reactor at a top portion 106 (i.e. circulation of the brine in a down-flow manner, FIG. 1A). Alternatively, the brine can be circulated via loop 110 through the active medium in an up-flow manner, as shown in FIG. 1B, e.g. extracted from the top of the reactor and fed back into the reactor at the bottom portion. NOx gaseous products at the headspace 108 formed above the active medium and liquid, can be evacuated and further treated, for example in one or more treatment modules 112 to form subsequent products (such as nitric acid, nitrogen gas and water). The treated brine exists the reactor through outlet 114 and can be further used as regenerated brine.

### Example 1: Treatment of Brine from Ion-Exchange Processes

Hybrid ion-exchange (IX) system are based on traditional IX system that removes nitrate from the water. Once the ion exchange resin is exhausted, the system is regenerated with brine solution containing about 100 g/l of NaCl. The exact concentration depends on the resin type and operational considerations. During regeneration, the Cl exchange the nitrate, as well as other anions, adsorbed on the resin. Consequently, the brine contains all the anions, including the nitrate, that were displaced from the resin by the chloride. Two sets of tests were carried out and will be detailed below:
1. The Hybrid IX Test-testing whether the process of this disclosure permits obtaining regenerated brine that is suitable for reuse in a hybrid system without significant decrease in the resin performance.
2. The Recovery Test-demonstrating selective removal of nitrate from used brine and recovering it as nitric acid.

### 1. Hybrid IX Test

Cycles of water treatment and regeneration were performed. In each cycle an IX column filled with Purolite A520E was first exhausted with tap water spiked to 100 mg/l of nitrate. Once exhausted the resin was regenerated (with brine) before the next cycle started. The used brine was then treated according to the process of this disclosure for further use in the experiment.

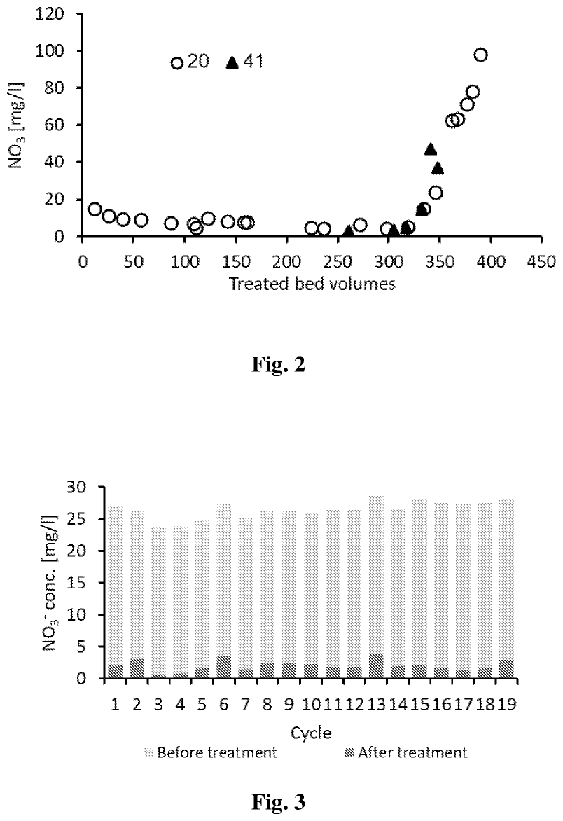

The tests imitated all the major components of a full-scale system hybrid IX, treating 30 gallons per hour of city water spiked with nitrate to a 100 mg/l nitrate. The spiked water passed through a column containing 9 liters of nitrate selective IX resin. The hybrid IX tests included 42 regeneration cycles. Each cycle was operated for about 72 hours before regenerating the resin. The concentration of nitrate at the outlet of the column followed a typical behavior for these type of resins as the concentration were kept below 10 mg/l for 300-350 BV (bed volumes), before a sharp breakthrough was observed. An example of such breakthrough curve is provided in FIG. 2 for cycles 20 and 41. Comparing the two breakthrough curves demonstrates that no degradation in the IX ability to remove nitrate was observed in the Hybrid IX Tests.

The Hybrid IX Test clearly shows that the process allows the reuse of the brine for IX regeneration with respect to the IX ability to remove nitrate.

### 2. Recovery Test

In these experiments, a synthetic brine (that was similar in its composition to the brine from the Hybrid IX Test) was treated by a process according to this disclosure. The gases emitted during the operation of the process were captured in a series of traps and the recovery of nitrogen, either as nitrate or nitrite, was measured. NOx gases (i.e. NO+NO₂) as well as CO, and SO₂, were measured in the tailing.

The recovery tests were conducted with synthetic brine containing 20-30 g/l of nitrate and 40-70 g/l of Cl⁻. This concentration ranges that were observed in the Hybrid IX Tests. In each cycle of the recovery experiment, the reactor treated 6 liters of brine. The concentration of nitrate was measured before and after the treatment in the brine and in the traps that were connected to the gas outlet (FIGS. 1A-1B). The ability of the reactor to remove nitrate is clearly demonstrated in FIG. 3 as the nitrate concentration in the brine dropped to below 4 g/l in all cycles. A target concentration for brine reuse was set to <5 g/l, as it allows to regenerate the IX resin over and over without prolonged degradation in IX capacity. The ability of the system to treat the brine to below 5 g/l suggests that it is possible to use it as part of an IX hybrid system.

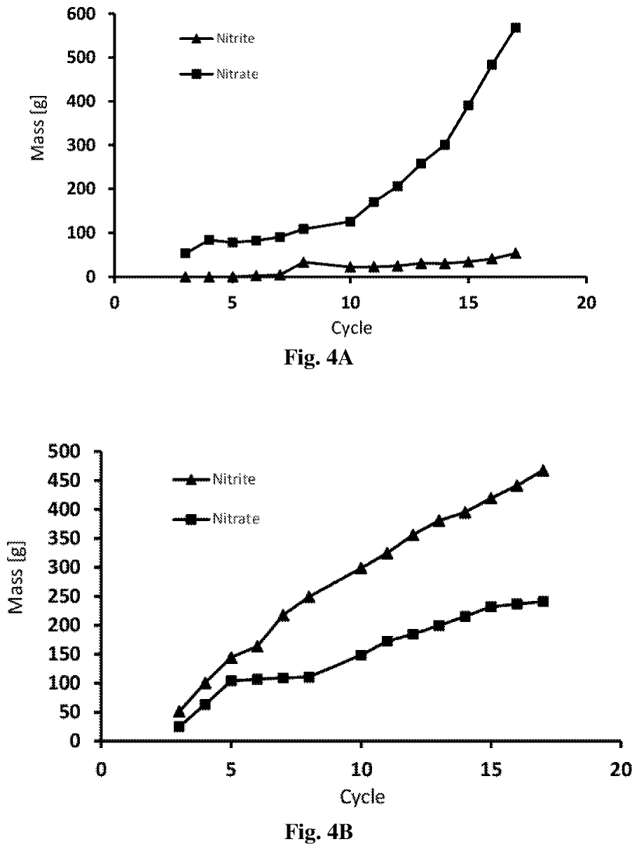

Unlike most suggested hybrid IX, the process and system herein were designed not only to treat the brine but also to recover the nitrate using a NOx convector. The gas outflow from the regeneration process was directed through a series of alkaline and acid traps that absorbed the gases either as nitrite or nitrate. According to the chemistry of the process described hereinabove, nitrite accumulates in the alkaline traps but not in the acid traps (as the pH there can get to <1 which is below the pKa of the nitrous acid, being 3.16). The accumulation of nitrate and nitrite in the acid and alkaline traps is depicted in FIG. 4A-4B respectively. The dominant nitrogen species in the acid traps was nitrate, while in the alkaline traps, nitrite was the dominant species.

The recovery is the amount of nitrogen that was accumulated in the traps with respect to the amount of nitrogen that was lost from the reactor. The recovery can be calculated by:

$$Recovery [ \% ] = \frac{\sum {ΔNO}_{3 traps}^{-} [ mol ] + {ΔNO}_{2 traps}^{-} [ mol ]}{{ΔNO}_{3 reactor}^{-} [ mol ]} \times 100 \qquad ( 1.6 )$$

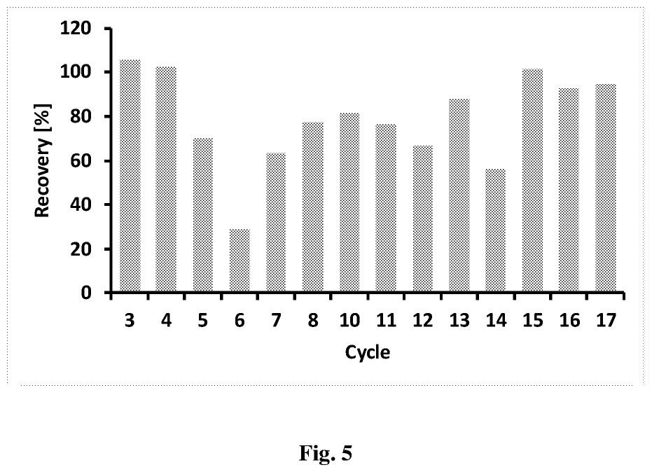

The recovery during the different cycles varies from 30% to over 100% (FIG. 5). This variance is mainly related to technical problems in the system. For example, a leak from the reactor was detected after cycle 6. Once it was fixed, the recovery increased in the following cycles. A recovery rate larger than 100% is related to analytical errors.

The average recovery in the traps was 79%. This means that about 20% of the nitrogen did not convert to either nitrite or nitrate in the traps and exited the system as gas. The tailing gas analysis showed that an additional 5% of the eliminated nitrate was recorded as NOx. However, it's important to note that this measurement does not include the nitrous acid portion.

### Example 2: Effect of Different Carbon Types

The effect of utilization of different types of activated carbon (Table 1) as active mediums on the efficiency of the process was assessed.

TABLE 1
Types of activated carbon

| Batch | Type | Source |
|---|---|---|
| A | Granular | Bituminous |
| B | Granular | Coconut shell |
| C | Granular | Coconut shell |
| D | Granular | Wood/plant |
| E | Powder | Unknown |

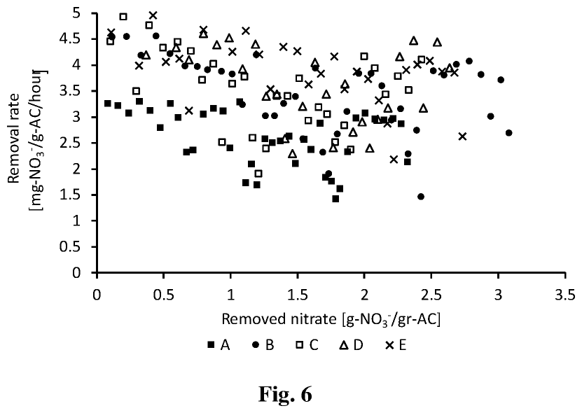

20 ml samples of activated carbon were batch-tested in 100 ml glass reactors, to which 40 ml of regeneration brine containing about 25 g/l of nitrate were introduced. The samples were tested in 30-40 batch cycles, in every such cycle fresh brine was introduced into the activated carbon and the reactors were heated to 90° C. for about 24 hours. Then the nitrate concentration was measured in each of the reactors. The nitrate removal rate, as milligrams of NO₃⁻ for each gram of AC per hour (mg-NO₃⁻/g-AC/hour), was then calculated. The results are provided in FIG. 6.

While some differences between the activated carbon types were observed, all tested activated carbon showed ability to remove nitrate from brine in the tested process conditions, with an average rate of 3.36 mg-NO₃⁻/g-AC/hour and a standard deviation of 0.9 mg-NO₃⁻/g-AC/hour. Hence, without wishing to be bound by theory, the process has little sensitivity to the type of activated carbon used.

### Example 3: Effect of Brine Feed Flow Direction

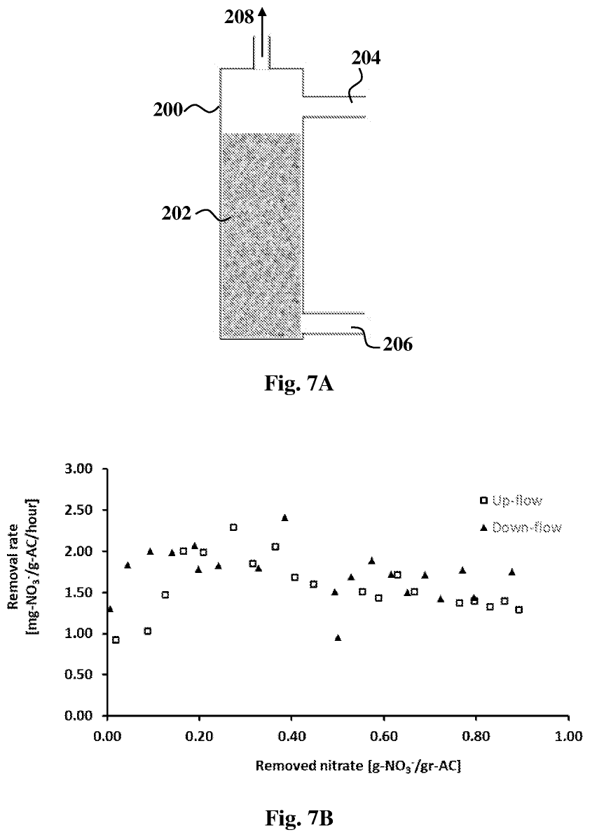

Continuous feed tests were performed a simplified system described schematically in FIG. 7A. A 50 mm glass column (200) was filled with 377 g of granular activated carbon (202). Column 200 included a gas outlet 208, and two brine ports: a top port 204 and a bottom port 206. The system was operated in two modes: Up-Flow mode in which the brine was introduced to the column through bottom port 206 and existed the column through top port 204, and Down-Flow mode in which the brine was introduced to the column through top port 204 and existed the column through bottom port 206. The flow rate ranged from 18-47 ml/hour. The rate of removal of NO₃⁻ in both modes of operation is shown in FIG. 7B.

As can be seen, similar rates were obtained for both flow modes; the average removal rate was 1.54 mg-NO₃⁻/g-AC/hour with a standard deviation of 0.42 mg-NO₃⁻/g-AC/hour. The tests show that the process can be operated in continuous mode and has little sensitivity to the direction of flow of brine within the reactor.

1. A process for removal of nitrate from nitrate-containing brine, the process comprising:
contacting, in a reactor, said nitrate-containing brine with an active medium, under conditions permitting conversion of said nitrate into nitrogen oxide gaseous products, and
removing said nitrogen oxide gaseous products from the reactor, thereby reducing the concentration of said nitrate in the nitrate-containing brine,
said conditions being selected to minimize formation of ammonia in the reactor.

2. The process of claim 1, wherein said conditions comprise contacting the nitrate-containing brine with the active medium in an oxygen-devoid atmosphere.

3. The process of claim 1, wherein said conditions comprise maintaining the temperature of the reactor at a range of between about 60° C. and about 99° C.

4. The process of claim 1, wherein said conditions comprise maintaining the reactor at a pH value of below about 3.

5. The process of claim 1, wherein the active medium occupies at least about 30% of the volume of the reactor.

6. (canceled)

7. The process of claim 1, wherein said active medium is activated carbon.

8. The process of claim 1, wherein said active medium is in granular or pellets form, having an average particle size of between about 0.1 mm and about 10 mm.

9. The process of claim 1, wherein the reactor is maintained under sub-atmospheric pressure.

10. (canceled)

11. The process of claim 1, wherein said brine comprises at least 100 ppm of nitrate.

12. The process of claim 1, comprises introducing one or more inert gases into the reactor, for purging said nitrogen oxide gaseous products from the reactor.

13. The process of claim 1, wherein the nitrate-containing brine and the active medium are contacted in an up-flow manner.

14. The process of claim 1, wherein the nitrate-containing brine and the active medium are contacted in a down-flow manner.

15. (canceled)

16. The process of claim 1, comprising pre-treating the nitrate-containing brine before introduction into the reactor to remove volatile contaminants.

17. The process of claim 1, comprising transferring said nitrogen oxide gaseous products to further processing for converting said nitrogen oxide gaseous products into nitric acid or into atmospheric nitrogen (N₂).

18. (canceled)

19. (canceled)

20. (canceled)

21. The process of claim 1, wherein the nitrate-containing brine is circulated through the active medium.

22. The process of claim 1, wherein the nitrate-containing brine is regeneration brine from an ion-exchange system, municipal wastewater, agricultural wastewater, industrial wastewater, waste brine from evaporation ponds, reverse osmosis brine, and spent nitric acid.

23. (canceled)

24. (canceled)

25. A process for recovery of nitrate in the form of nitric acid from nitrate-containing brine, the process comprising:
contacting, in a reactor, said nitrate-containing brine with an active medium that comprises activated carbon, under conditions permitting conversion of said nitrate into nitrogen oxide gaseous products,
removing said nitrogen oxide gaseous products from the reactor, and
treating said nitrogen oxide gaseous products in one or more treatment stages, thereby obtaining nitric acid.

26. The process of claim 25, wherein said one or more treatment stages comprise contacting said nitrogen oxide gaseous products with oxygen.

27. The process of claim 25, wherein said one or more treatment stages comprise contacting said nitrogen oxide gaseous products with water.

28. The process of claim 25, wherein said one or more treatment stages comprise contacting said nitrogen oxide gaseous products by reaction with an alkali or acid solution.

29. The process of claim 25, wherein said one or more treatment stages comprises converting said nitrogen oxide gaseous products into atmospheric nitrogen (N₂).
